(19) United States
(12) Patent Application Publication
(10) Pub. No.: US 2024/0031310 A1
(43) Pub. Date: Jan. 25, 2024

(54) SYSTEM FOR PROVIDING A CHATBOT COMMUNICATIONS NETWORK BETWEEN A PLURALITY OF USERS INCLUDING MERCHANTS AND CLIENTS

(71) Applicant: APP-POP-UP INC., Winnipeg (CA)

(72) Inventors: Rajeev KUMAR, Disraeli (CA); Rakesh KUMAR, Disraeli (CA)

(21) Appl. No.: 17/974,616

(22) Filed: Oct. 27, 2022

Related U.S. Application Data
(60) Provisional application No. 63/390,529, filed on Jul. 19, 2022.

(51) Int. Cl. H04L 51/02; H04L 51/18; G06Q 30/02

(52) U.S. Cl. CPC H04L 51/02; H04L 51/18; G06Q 30/0281

(57) ABSTRACT

A computer-implemented system provides a chatbot communications network between a plurality of system participating users including merchants and clients. The system comprises a system controller with a memory. A user device communicates with the system controller and comprises an input/output interface for inputting commands to the system controller and for outputting information from the system controller. The system controller creates at least one chatbot framework for a responding user such as a merchant. User content is converted in real time content into converted chatbot content within the chatbot framework. A chatbot interface is created to be communicated to initiating users such as clients via the input/output interface. Initiator users such as clients input queries and/or commands from their user device related to responding user content such as merchant content via the user chatbot interface. The chatbot framework produces chatbot outputs related to the converted chatbot content in response to the input queries and/or commands. and communicates the chatbot outputs via the user chatbot interface.

### CROSS-REFERENCE TO RELATED APPLICATIONS

The present application claims priority on U.S. Provisional Patent Application Ser. No. 63/390,529 filed on Jul. 19, 2022, and incorporated herein by reference in its entirety.

### TECHNICAL FIELD

The present disclosure generally relates to chatbots. More particularly, but not exclusively, the present disclosure relates to a system for providing a chatbot communications network between a plurality of users including merchants and clients.

### BACKGROUND

A chatbot or chatterbot or a bot is a software application used to conduct an on-line chat conversation via text or text-to-speech, in lieu of providing direct contact with a live human agent. A chatbot is a computer program that simulates a natural human conversation. Users communicate with a chatbot via the chat interface or by voice, similarly to how they would talk to a real person. Chatbots interpret and process users' words or phrases and give an instant pre-set answer. Artificial intelligence (AI), natural language processing (NLP), and machine learning are chatbot underlying technologies. A chatbot assists customers by automating conversations and interacting with them through messaging platforms. Chatbots simulate the way a human would behave as a conversational partner. Chatbots are used in dialog systems for various purposes including customer service. Chatbots are accessed on-line via website popups or through virtual assistants. Chatbots are increasingly present in businesses and often are used to automate tasks that do not require skill-based talents.

### OBJECTS

An object of the present disclosure is to provide a computer-implemented system for providing a chatbot communications network between a plurality of users including merchants and clients.

An object of the present disclosure is to provide a computer-implemented method for providing a chatbot communications network between a plurality of users including merchants and clients.

### SUMMARY

In accordance with an aspect of the present disclosure, there is provided a computer-implemented system providing a chatbot communications network between a plurality of system participating users, the system comprising: a system controller comprising a processor with an associated memory of computer executable code that when executed provides the system controller of performing computer implementable steps; at least two user devices associated with at least two respective users, wherein each of the user devices comprises: a user controller in operative remote communication with the system controller via a network communication and comprising a processor with an associated memory, the user controller enabling internet access via a network communication; and an input/output interface in operative communication with the user controller and providing for inputting commands to the system controller and for outputting information from the system controller; user content associated with each of the respective users and being selected from the group consisting of: (i) content stored within the memory of the user controller, (ii) content stored within a memory of another remote controller associated with the respective user and accessible via the user controller, (iii) online content associated with the respective user and accessible via the user controller and any combination thereof, wherein the computer implementable steps performed by the system controller comprise: creating at least one chatbot framework associated with each participating user requesting same via input commands; converting in real time the user content into converted chatbot content within the chatbot framework; creating a user interface to be communicated to users via the input/output interface; receiving input queries and/or commands from the at least one initiator user related to user content of another responder user via the user chatbot interface; providing for the chatbot framework to produce chatbot outputs related to the converted chatbot content of the responder user in response to the input queries and/or commands; and communicating the chatbot outputs via the user chatbot interface to the initiator user.

In an embodiment, the computer implementable steps performed by the system controller further comprise storing the converted chatbot content within the chatbot framework.

In an embodiment, the step of providing the chatbot framework to produce chatbot outputs comprises the computer implementable steps of: analyzing the input queries and/or commands to provide analyzed input; searching the converted chatbot content based on the analyzed input; and determining at least one match between the analyzed input and relevant content of the searched converted chatbot content, wherein the chatbot outputs comprise the relevant content. In an embodiment, the system controller performs the computer implementable step of transferring the received input queries and/or commands to the chatbot framework.

In an embodiment, the chatbot framework is stored within the system controller associated memory.

In an embodiment, the chatbot framework is stored within the user controller memory.

In an embodiment, system controller performs the computer implementable step of providing participating users to create with input commands, via the input/output interface of respective ones of the user devices, respective user profiles associated with respective user identifiers and stored within the system controller memory. In an embodiment, the system controller performs the computer implementable step of communicating the respective user identifiers via the input/output interface thereby providing a given participating user to select another given participating user for inquiring about the user content thereof by selecting a given user identifier associated therewith via input commands via the input/output interface.

In an embodiment, the system controller performs the computer implementable steps of: creating a master chatbot interface to be communicated to the initiator user via the input/output interface for providing the initiator user to simultaneously input queries and/or commands related to one or more of the user content of one or more of the responder users; creating a master chatbot framework stored in the system controller memory for coordinating the respective ones of the chatbot frameworks associated with the respective ones of the responder users; providing the master chatbot framework to coordinate the chatbot outputs simultaneously and/or concurrently produced by the respective ones of the chatbot frameworks in response to the simultaneous input queries and/or commands thereby producing a coordinated collective chatbot output; and communicating the coordinated collective chatbot output via the master chatbot interface.

In an embodiment, the system controller performs the computer implementable step of monitoring user activity of a given one of the participating users and registering this using activity within a respective one of the user profiles associated with the given one of the participating users.

In an embodiment, the system controller performs the computer implementable step of creating an artificial-intelligence (AI) generated virtual assistant associated with a respective user profile for inputting queries and/or commands via the chatbot interface related to the responder user content based on the user profile of the initiator user.

In an embodiment, there is provided a chatbot communications network between a plurality of system participating merchants and system participating clients, the system comprising: a system controller comprising a processor with an associated memory of computer executable code that when executed provides the system controller of performing computer implementable steps; at least one client device associated with at least one client in operative remote communication with the system controller via a network communication and comprising an input/output interface for inputting commands to the system controller and for outputting information from the system controller; at least one merchant controller associated with at least one system participating merchant being in operative remote communication with the system controller via a networked communication and comprising a processor with an associated memory comprising stored merchant content directed to potential system participating clients; wherein the computer implementable steps performed by the system controller comprise: creating at least one chatbot framework for the at least one merchant controller; converting in real time the stored merchant content into converted chatbot content within the chatbot framework; creating a client chatbot interface to be communicated to clients via the input/output interface; receiving input queries and/or commands from the at least one client device related to merchant content via the client chatbot interface; providing for the chatbot framework to produce chatbot outputs related to the converted chatbot content in response to the input queries and/or commands; and communicating the chatbot outputs via the client chatbot interface.

In an embodiment, the computer implementable steps performed by the system controller further comprise storing the converted chatbot content within the chatbot framework.

In an embodiment, the step of providing the chatbot framework to produce chatbot outputs comprises the computer implementable steps of: analyzing the input queries and/or commands to provide analyzed input; searching the converted chatbot content based on the analyzed input; and determining at least one match between the analyzed input and relevant content of the searched converted chatbot content, wherein the chatbot outputs comprise the relevant content. In an embodiment, the system controller performs the computer implementable step of transferring the received input queries and/or commands to the chatbot framework.

In an embodiment, the chatbot framework is stored within the system controller associated memory.

In an embodiment, the chatbot framework is stored within the merchant controller memory.

In an embodiment, the system controller performs the computer implementable step of providing participating clients to create with input commands, via the input/output interface of respective ones of the client device, respective client profiles associated with respective client identifiers and stored within the system controller memory.

In an embodiment, the system controller performs the computer implementable step of providing a plurality of participating merchants associated with respective ones of the merchant controller to create with merchant controller input commands. respective merchant profiles associated with respective merchant identifiers stored within the system controller memory, wherein each of the respective ones of the merchant controller comprises respective merchant content and is associated with respective ones of the chatbot framework created therefor by the system controller. In an embodiment, the system controller performs the computer implementable step of communicating the respective merchant identifiers via the client input/output interface thereby providing a given participating client to select a given participating merchant for inquiring about the merchant content thereof by selecting a given merchant identifier with input commands via the client input/output interface.

In an embodiment, the system controller performs the computer implementable steps of: creating a master chatbot interface to be communicated to clients via the input/output interface for providing clients to simultaneously input queries and/or commands related to one or more of the respective merchant content of the respective ones of the merchant controller; creating a master chatbot framework stored in the system controller memory for coordinating the respective ones of the chatbot frameworks associated with the respective ones of the merchant controller; providing the master chatbot framework to coordinate the chatbot outputs simultaneously and/or concurrently produced by the respective ones of the chatbot frameworks in response to the simultaneous input queries and/or commands thereby producing a coordinated collective chatbot output; and communicating the coordinated collective chatbot output via the master chatbot interface.

In an embodiment, the system controller performs the computer implementable step of monitoring a given one of the client activity within the system and registering this activity within the client profile.

In an embodiment, the system controller performs the computer implementable step of creating an artificial-intelligence (AI) generated virtual assistant associated with a respective client profile for inputting queries and/or commands via the chatbot interface related to the merchant content based on the client profile.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic representation of the system for providing a chatbot communications network between a plurality of users such as merchants and clients in accordance with a non-restrictive illustrative embodiment of the present disclosure;

FIG. 2 is a schematic representation of the system controller of the system of FIG. 1 in accordance with a non-restrictive illustrative embodiment of the present disclosure;

FIG. 3 shows a prior art operative communication between a client input/output interface and a merchant controller;

FIG. 4 is a schematic representation of the system for providing a chatbot communications network between a plurality of users such as merchants and clients in accordance with a non-restrictive illustrative embodiment of the present disclosure;

FIG. 5 is a schematic representation of the system for providing a chatbot communications network between a plurality of users such as merchants and clients in accordance with a non-restrictive illustrative embodiment of the present disclosure;

FIG. 6 is a schematic representation of the client/output interface of the system of FIG. 5 in accordance with a non-restrictive illustrative embodiment of the present disclosure;

FIG. 7 is a schematic representation of the system for providing a chatbot communications network between a plurality of users such as merchants and clients in accordance with a non-restrictive illustrative embodiment of the present disclosure;

FIG. 8 is a schematic representation of the system for providing a chatbot communications network between a plurality of users such as merchants and clients in accordance with a non-restrictive illustrative embodiment of the present disclosure;

FIG. 9 is a schematic representation of a client input/output interface of a system for providing a chatbot communications network between a plurality of users such as merchants and clients in accordance with a non-restrictive illustrative embodiment of the present disclosure;

FIG. 10 is a schematic representation of a client input/output interface of a system for providing a chatbot communications network between a plurality of merchants and clients in accordance with a non-restrictive illustrative embodiment of the present disclosure;

FIG. 11 is a schematic representation of the system for providing a chatbot communications network between a plurality of users in accordance with a non-restrictive illustrative embodiment of the present disclosure

FIG. 12 is a schematic representation of the system controller of the system of FIG. 11 in accordance with a non-restrictive illustrative embodiment of the present disclosure;

FIG. 13 is schematic representation of a user profile stored within the system controller of the system of FIG. 11 in accordance with a non-restrictive illustrative embodiment of the present disclosure;

FIG. 14 is a schematic representation of a controller with a stored user profile associated with a chatbot framework 11 in accordance with a non-restrictive illustrative embodiment of the present disclosure; and

FIG. 15 is a schematic representation of the system for providing a chatbot communications network between a plurality of users in accordance with a non-restrictive illustrative embodiment of the present disclosure.

### DETAILED DESCRIPTION OF ILLUSTRATIVE EMBODIMENTS

Generally stated and in accordance with an aspect of the present disclosure, there is provided a computer-implemented system providing a chatbot communications network between a plurality of system participating users. The system comprises a system controller with a memory. A user device communicates with the system controller and comprises an input/output interface for inputting commands to the system controller and for outputting information from the system controller. The system controller creates at least one chatbot framework for a responding user such as a merchant. User content is converted in real time content into converted chatbot content within the chatbot framework. A chatbot interface is created to be communicated to initiating users such as clients via the input/output interface. Initiator users such as clients input queries and/or commands from their user device related to responding user content such as merchant content via the user chatbot interface. The chatbot framework produces chatbot outputs related to the converted chatbot content in response to the input queries and/or commands. and communicates the chatbot outputs via the user chatbot interface.

In accordance with an aspect of the present disclosure, the system comprises a system controller comprising a processor with an associated memory of computer executable code that when executed provides the system controller of performing computer implementable steps. The system comprises at least two user devices are associated with at least two respective users. The user device comprises a user controller in operative remote communication with the system controller via a network communication and comprising a processor with an associated memory. The user controller enables internet access via a network communication. The user device comprises an input/output interface in operative communication with the user controller which provides for inputting commands to the system controller and for outputting information from the system controller. User content associated with each of the respective users is selected from the group consisting of: (i) content stored within the memory of the user controller, (ii) content stored within a memory of another remote controller associated with the respective user and accessible via the user controller, (iii) online content associated with the respective user and accessible via the user controller and any combination thereof. The system controller creates at least one chatbot framework associated with each participating user requesting same via input commands. User content is converted in real time into converted chatbot content within the chatbot framework. A user interface is created to be communicated to users via the input/output interface. The system controller receives input queries and/or commands from the at least one initiator user related to user content of another responder user via the user chatbot interface. The chatbot framework produces chatbot outputs related to the converted chatbot content of the responder user in response to the input queries and/or commands. The chatbot outputs are communicated via the user chatbot interface to the initiator user.

In an accordance with an aspect of the present disclosure, the system participating users include clients and merchants. The system comprises a system controller with a memory. At least one client device is in operative remote communication with the system controller and comprises an input/output interface for inputting commands to the system controller and for outputting information from the system controller. At least one merchant controller is in operative remote communication with the system controller and comprises a memory comprising stored merchant content directed to potential system participating clients. The system controller creates at least one chatbot framework for the at least one merchant controller, converts in real time the stored merchant content into converted chatbot content within the chatbot framework, stores the converted chatbot content within the chatbot framework, creates a client chatbot interface to be communicated to clients via the input/output interface, receives input queries and/or commands from the at least one client device related to stored merchant content via the client chatbot interface. provides for the chatbot framework to produce chatbot outputs related to the converted chatbot content in response to the input queries and/or commands. and communicates the chatbot outputs via the client chatbot interface.

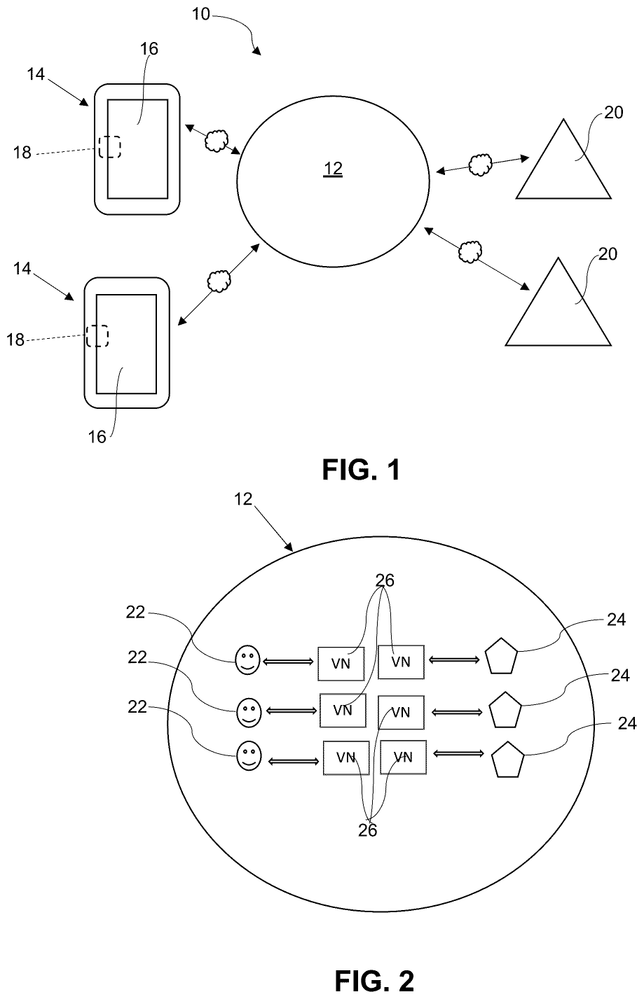

With reference to FIG. 1, there is shown a system 10 for providing a chatbot communications network between a plurality of users including clients and merchants. The system comprises a system controller 12 comprising a processor with an associated memory of computer executable code that when executed provides for performing computer implementable steps.

Each client has a respective client device 14 in operative remote communication with the system controller 12 via a network communication. The client device 14 is selected from the group consisting of a mobile device, a PC, a laptop and the like and includes an input/output interface 16 for inputting commands to the system controller 12 and for outputting information from the system controller 12. The client device 14 comprises a controller 18 having a processor with an associated memory of processor executable code that when executed provides for performing computer implementable steps. The client device controller 18 is in operative remote communication with the system controller 12 via a networked communication.

Each merchant has a respective merchant controller 20 in operative remote communication with the system controller 12 via a networked communication. The merchant controller 20 comprises a processor with an associated memory of processor executable code that when executed provides for performing computer implementable steps.

The system controller 12 performs the computer implementable step of providing a chatbot communication between a given client device 14 and a given merchant controller 20.

In an embodiment, the system controller 12 executes the computer implementable steps of providing participating clients and merchants to create respective profiles via input commands within the memory of the system controller 12. Indeed, the system controller 12 may not require such profiles and users can participate directly by logging into the system 10. As shown in FIG. 2, the system controller 12 executes the computer implementable step of storing participating client profiles 22 and participating merchant profiles 24 in its memory. The system controller 12 performs the computer implementable step of creating distinct non-duplicated user identification ID 26. In an embodiment, the user ID comprises a virtual phone number (VN), wherein each VN 26 is associated with a respective one of the participating client or merchant profiles, 22 or 24. In an embodiment, the VN 26 is used within a Voice over Internet Protocol (VoIP).

In this way, each client profile 22 is associated with its own distinct non-duplicated user ID (e.g., VN 26). The client profile 22 also includes information related to the client device 14. As such, the system controller 12 associates a client profile 22 with a user ID (e.g., VN 26) and with a client device 14. Each merchant profile 24 is associated with its own distinct non-duplicated user ID (e.g., VN 26). Each merchant profile 24 comprises information related to the merchant controller associated therewith. As such, the system controller 12 associates a merchant profile 24 with a user ID (e.g., VN 26) and with a merchant controller 20.

In an embodiment, the system controller allocates more than one VN 26 to each user. For example, a merchant may have several stores in various countries or continents and can have several virtual numbers, one for each country or regions (for example, A US VN, a European VN etc.).

In an embodiment, the user ID is a real mobile/cellular and/or landline telephone number and/or an email and/or a social media contact link, a username, a serial number, and the like and combinations thereof. In an embodiment, during client-merchant communications and/or client-client communications and/or merchant-merchant communications and/or user group communications as well as combinations thereof within the system 12 as provided herein, user IDs are displayed via the interfaces provided herein including without limitation virtual numbers, real telephone numbers, email addresses, social media links, usernames, serial numbers icons, avatars and the like and combinations thereof as can be contemplated by the skilled artisan to provide any type of networked communication as is known in the art. In an embodiment, the network communications herein can be provided by a cellular network and/or an internet network jointly or separately as per availability.

In an embodiment, the system controller 12 performs the computer implementable step of providing an internet connection (automatically or upon request) to the client device 14 via the user UD such as VN 26.

In an embodiment, the virtual number VN 26 is associated with a real telephone number. In an embodiment, the real telephone number associated with the virtual number is displayed via the interfaces herein. In an embodiment, users via input commands select which type of user ID they wish to be displayed via the communication interfaces herein and/or to which other system users they wish the given user ID to be displayed to and when and under what circumstances etc. The foregoing parameters are modulated via user input commands in real time during system use or registered within the user profile 22. Accordingly, a user profile 22 can include more than one user ID 26 associated therewith. The various user IDs of a given profile 22 are linked thereto as provided herein and the user can select via unput commands a given one or more of its various user IDs to be displayed to a given one or more other users via the interfaces herein.

It is to be understood that the examples herein regarding virtual numbers VN 26 are applicable to other types of user IDs or combinations thereof as provided herein and thus any type of user ID can replace a given VN 26 in the examples herein.

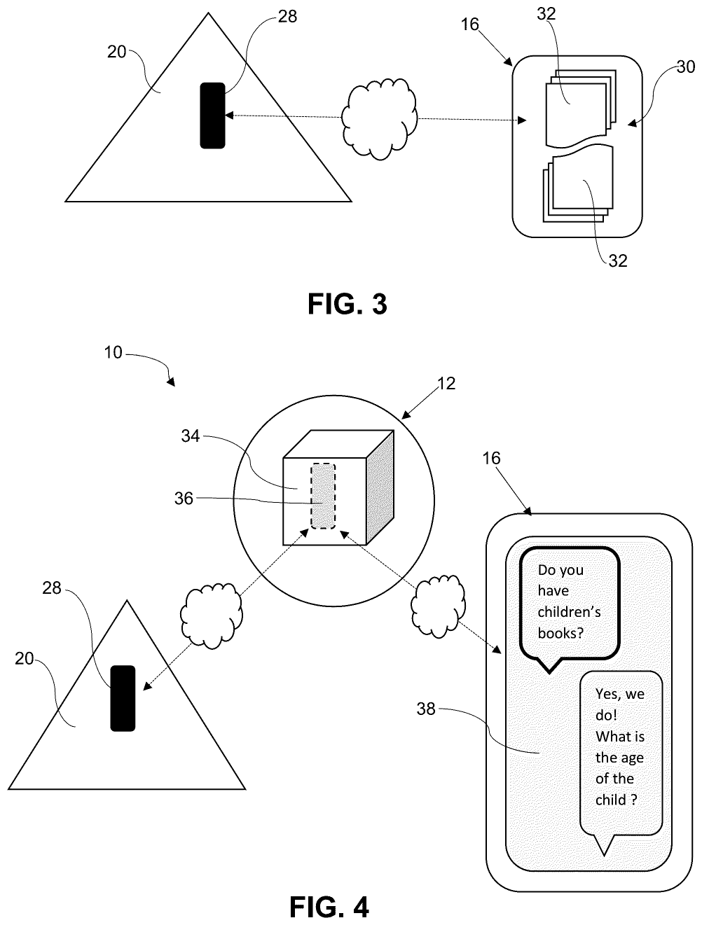

Turning to FIG. 3, each merchant controller 20 has a memory with content 28 including one or more websites or applications 28 for providing user interfaces 30 to be displayed on client input/output interface 16 (such as a display screen). The user interface 30 may include item icons 32 with relevant information that the client can peruse, select, and/or purchase as is known in the art.

It should be noted that the merchant controller 20 need not be a single unit but could also be an assembly of controllers including a cloud platform and the like as can be contemplated by the skilled artisan.

Turning to FIG. 4, the system controller 12 performs the computer implementable step of creating a chatbot framework 34 for each merchant controller 20. The system controller 12 performs the computer implementable step of converting in real time the content 28 including websites, information of the merchant application 28 into the chatbot framework 34, wherein the chatbot framework 34 stores the converted content 36 of application 28 therein in real time. The system controller 12 performs the computer implementable step of creating a client chatbot interface 38 to be displayed via the user input/output interface 16. In this way, rather than the user perusing the merchant provided interface 30, the user can access the information displayed on interface 30 via chatbot communication.

For example, and turning to FIG. 3, the interface 30 provides a list of books 32 for sale that the client can peruse, select, and purchase. Indeed, the client can click on a given book icon 32 and find out more about the product, including price, reviews, similar books, and the like as is known in the art. The system controller 12 provides for converting the foregoing shopping experience into a chatbot experience. As such, and turning to FIG. 4, instead of the client surfing the merchant's website via interface 30, the client can access the information provided by the merchant content 28 via the converted content 36 within the chatbot framework 34 by way of the chatbot interface 38. Accordingly, the user can ask for types of books and the chatbot system will respond as is known in the art. The chatbot communications system can be modulated based on the merchant requirements and types of products and services. Indeed, purchasing is completed directly via the chatbot interface 38 by the chatbot framework 34 requesting purchase order information and by the client inputting purchase order commands via the input/output interface 16 directly into the chatbot interface 38. Of course, the client profile 22 can include credit card or other payment information which facilitates purchase orders.

In an embodiment, the merchant content 28 comprises an online website and the converted content 36 comprises displaying selective fragments or portions of the website via the chatbot interface 38 in response to input queries from a client. The chatbot interface 38 will display a fragment or portion of the merchant's website related to that question. For example, when requesting information on a particular product or service the chatbot interface 38 displays the fragment or portion of the website related to that product.

In another embodiment, the merchant content 28 comprises a merchant video. The chatbot framework converts the content 28 by splitting that video into separate time stamp portions which are related to pre-identified subjects within a video. For example, a video regarding car maintenance may have separate subjects related to tires, engine, muffler etc. When a client requests a question on a particular maintenance subject, the chatbot framework identifies that subject and displays only the video portion related thereto via the chatbot interface 38. In another embodiment, the chatbot framework divides the video into fragments and identifies keywords in each of the fragments. The client can input questions and the chatbot framework can display video fragments including keywords related to those questions. The chatbot framework's video fragment identification is improved via machine learning.

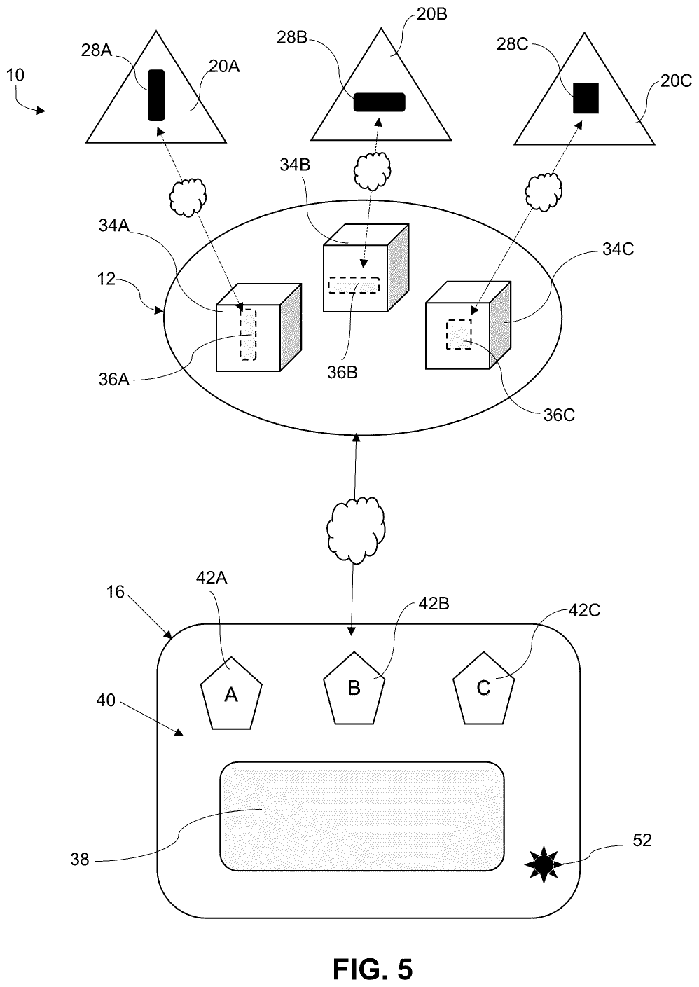

Turning now to FIG. 5 and based on the foregoing, the system controller 12 performs the same steps for multiple participating merchants as such, the system controller 12 provides a respective chatbot framework 34A, 34B, 34C for respective participating merchant controllers 20A, 20B, 20C containing respective merchant content 28A, 28B, 28C stored in their respective memories or accessible thereto via network communication for example. The system controller 12 converts in real time the respective content 28A, 28B, 28C into their chatbot frameworks 34A, 34B, 34C, wherein each respective chatbot framework 34A, 34B, 34C, stores the respective converted content 36A, 36B, 36C of the respective applications 28A, 28B, 28C therein in real time. The system controller 12 performs the computer implementable step of providing a client interface 40 via the client display 16 including a list of icons 42A, 42B, 42C, with each icon being associated with a respective merchant controller 20A, 20B, 20C. In this way, a client chooses which of the participating merchants (symbolized by icons 42A, 42B, 42C) they wish to communicate with via the chatbot communication by clicking on an icon 42A, 42B, 42C and inputting communication requests/commands via the chatbot interface 38.

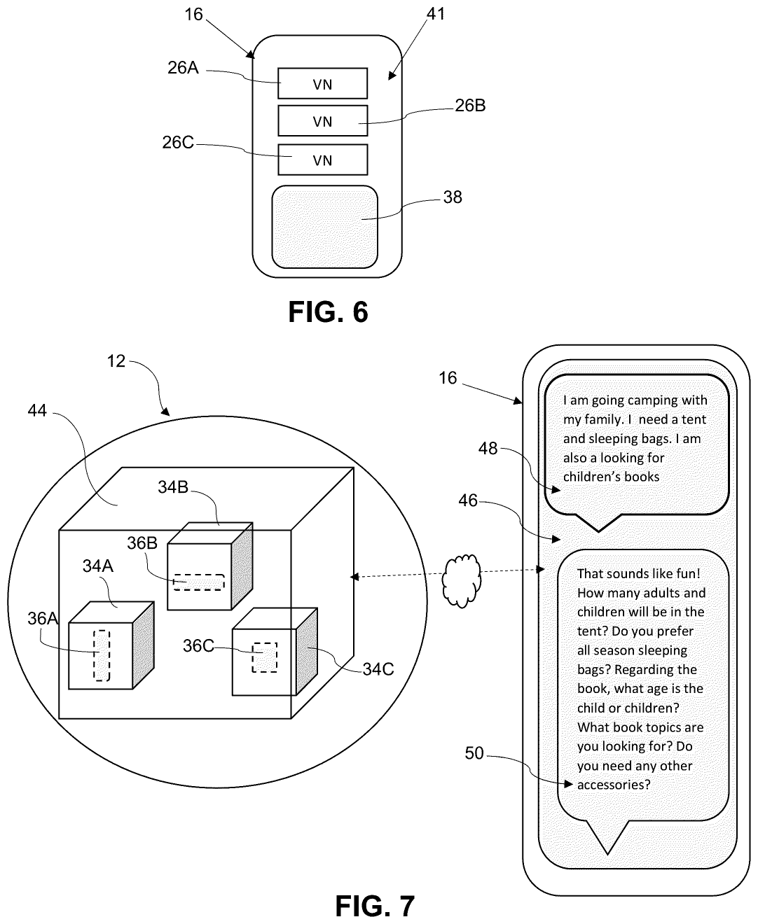

Referring to FIG. 6, the system controller 12 performs the computer implementable step of providing a client interface 41 via the client display 16 including a list of virtual numbers (VN) 26A, 26B, 26C with each VN 26A, 26B, 26C being associated with a respective merchant controller 20A, 20B, 20C. In this way, a client chooses which of the participating merchants they wish to communicate with via chatbot communication by clicking on a VN icon 26A, 26B, 26C and inputting communication requests/commands via the chatbot interface 38. Alternatively, the chatbot interface is a voice operated system. Thus, the client uses their client device 14 (mobile device) to speak directly to a virtual agent. Rather than typing input commands, the client uses their voice to ask questions and receives voice responses and/or further questions as is known in the art.

With reference to FIG. 7 and referring to FIG. 5, the system controller 12 creates chatbot frameworks 34A, 34B, 34C, wherein each respective chatbot framework 34A, 34B, 34C, stores the respective converted content 36A, 36B, 36C of the respective applications 28A, 28B, 28C therein in real time. In this example, we have three participating merchants, one merchant is a bookstore, another merchant sells outdoor, camping and fishing equipment and a third merchant sells electronic devices. As such, the converted content 36A, 36B, 36C relates to books, outdoor, camping, fishing equipment and electronic devices provided by the websites of these merchants as previously explained. The system controller 12 performs the computer implementable step of creating a master chatbot framework 44 comprising all the chatbot frameworks 34A, 34B, 34C created thereby. The system controller 12 performs the computer implementable step of creating a master chatbot interface 46 displayed via display 16 as previously discussed. In this way, the client does not need to pick a given merchant to communicate and/or transact with as provided hereinabove but may communicate with all participating merchants simultaneously in a streamlined manner provided by the master chatbot framework 44. As exemplified in FIG. 7, the client may search for multiple items via the master chatbot interface 46 asking via command inputs 48 for camping equipment and books and the master chatbot framework 44 manages the chatbot frameworks 34A, 34B, 34C (i.e., subsidiary chatbot frameworks) to provide unitary responses 50 including additional questions. The system controller 12 performs the computer implementable step of providing a unitary checkout for purchasing all items from various merchant “stores” in a single purchase. The system controller 12 performs the computer implementable step of individually paying each merchant for the purchased item therefrom. This can be done by various ways. For example, the merchant profiles may include bank accounts, payment accounts, credit card accounts to which funds can be forwarded. Indeed, the system controller 12 can charge an additional amount per collective purchase as it is acting as a facilitator and manager for multiple merchants.

Turning back to FIG. 5, a client may choose to use the master chatbot interface 46 instead of selecting individual merchant icons 42A, 42B, 42C by clicking on a master chatbot interface icon 52. Indeed, the client can also select a group of merchants to simultaneously transact with as provided herein via the master chatbot interface 46. As such, the icon 52 can provide the option of communicating with all merchants or with a sub-group of merchants or still with a selected group of merchants. With respect to “all merchants” this can refer to the merchants that the client has downloaded the icons of directly in its device controller 18 or in its profile 22 or all participating merchants that have uploaded profiles 24 in the system controller 12. In a non-limiting embodiment given here by way of example only, when the client clicks on ion 52, a list of options appears including “ALL”, “SELECT”, “GROUPS”. By clicking on “ALL”, the client can transact with “all merchants”. The “ALL” tab can open a sub-list of tab options in order for the client to select between all participating merchants or all merchants that the client has downloaded icons of in its device 14 or in its profile 22. The “SELECT” option provides for opening a list of all participating merchant icons in the system controller 12 or all previously downloaded icons in the device 14 or profile 22 and the “SELECT” option may open a sub-list of options for choosing between the foregoing. The “GROUP” selection allows the client to choose merchants listed in various groups it has created such as “preferences”, “local” or “frequently used” with the latter being updated by the system controller 12 based on client usage and purchase. Indeed, the client can modulate the list of participating merchants it collectively transacts through the master chatbot interface 46 with via a variety of useful and convenient ways within the scope of the present disclosure.

In an embodiment, the system controller provides a chatbot framework 34 that creates more than one chatbot for the merchant. Indeed, a merchant may have several departments (such as a department store) and the framework 34 creates a respective chatbot for each respective department, allowing clients to transact with the Men's wear or Kitchen appliances department of a given store for example. In another example, the chatbot framework of a given merchant creates different chatbots for each transaction location i.e., if a client is in Asia it will access an Asia related chatbot or if the client is in North America, it will access a North American related chatbot. Therefore, this given merchant has chatbots for each location and may have further chatbots for each department as well. In an embodiment, the system controller 12 provides a master chatbot framework for to the merchant to coordinate subsidiary chatbot frameworks. Each of the subsidiary chatbot frameworks provides respective chatbots each being related to a store department, store location or other subdivision of the merchant. The master chatbot framework can thus consolidate the converted content of the various subsidiary chatbots into one master chatbot as provided above for the master chatbot interface 46.

Thus, system controller 12 can provide master chatbot frameworks to clients and/or merchants.

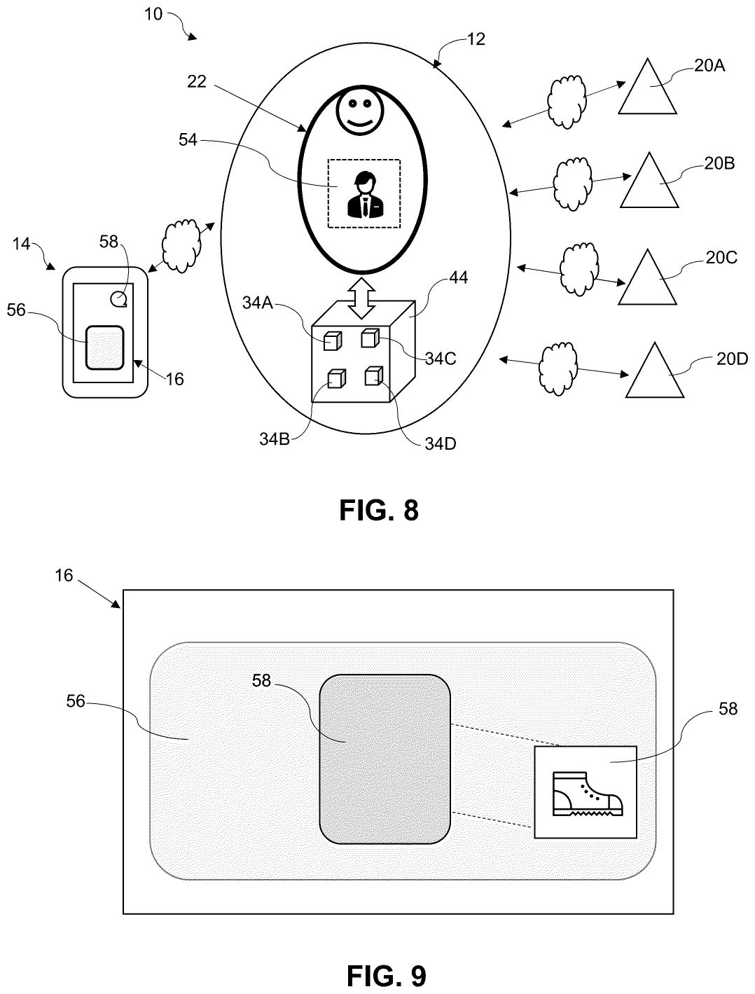

With reference to FIG. 8, the system controller 12 performs the computer implementable step of providing an artificial intelligence (AI) powered virtual assistant software 54 associated with a client profile 22. The virtual assistant 54 is modulated based on the preferences of the client which are entered into the system control 12 memory with input commands via the client device 14 (including key commands or voice commands), and/or by client activity within the system 10 as tracked by the system controller 12. This activity includes client preferences in terms of products and services purchased including costs, time periods, quality, brands, location and the like as can be contemplated by the skilled artisan and as is known in the art within the context of the present disclosure. Accordingly, the virtual assistant 54 communicates with the master chatbot framework 44 and/or with the subsidiary chatbot frameworks 34A, 34B, 34C, 34D directly. The system controller 14 performs the computer implementable step of providing a virtual assistant interface 56 displayed in the display 16 of the client device 14. Indeed, a client can input commands via the client device 14 to the system controller 14 such as inquiring for a vacation. In one example, the client can type into the virtual assistant interface 56 “I want to go on vacation soon”, in another example, the client can speak into the device 14 and ask the question vocally to the virtual assistant 54. The system controller 14 displays an icon 58 via the display 16 which when selected by the user activates the virtual assistant written message interface 56 or the voice interface. The virtual assistant 54 can respond either by vocal or written message as provided herein with: “What type of vacation do you want? Beach, sightseeing, or a mix of both? Do you prefer Caribbean, South American, European or whatever has the better deal?”

The AI powered virtual assistant 54 formulates questions based on pre-determined parameters that the client has already registered in their profile 22 regarding their preferences as well as their activity history i.e., the types of vacations they have taken etc. When the virtual assistant 54 completes its assessment of the client's wants and needs it will then shop for potential packages via the master chatbot framework 44 shopping for flights, hotels, car rentals, tour packages and other items based on the client pre-determined preferences in their profile 22, their activity history as recorded by the system controller 14 and registered within their profile 22 and on the responses to additional questions formulated by the virtual assistant 54 based on additional questions as the order assessment is further refined. The virtual assistant 54 may be provided with access to the client's work calendar such as an online calendar and thus can also determine the best times for a vacation. Thus and as will be further discussed below, the profile 22 includes a static portion where the client enters information and a dynamic portion which is updated based on the client's activity history including perusal activity, shopping activity, questions they asked, previous answers they provided to chatbots and virtual assistants providing a dynamic profile section that allows for the chatbots and virtual assistants herein to base their machine learning thereon as is understood by the skilled artisan. The virtual assistant 54 assembles vacation packages (destination, dates, flights, hotels, car rentals, tours, other required accessories, prices) and displays these package results to the client for approval or for additional request. The virtual assistant 54 accesses the credit card information stored in the profile 22 and purchases the package via the master chatbot framework's unitary purchase checkout and the system controller 12 pays the various merchant controllers 20A, 20B, 20C and 20D directly for the various purchases. The virtual assistant 54 keeps in contact with the merchant controllers 20A, 20B, 20C and 20D via the master chatbot framework 44 and receives the various confirmation, tickets, tracking numbers which it assembles and provides in the form of a single email with attachments to the client's email preferred email addresses or saves the package on the client device 14 in a predetermined folder.

In an embodiment, a plurality of virtual assistants 54 are associated with the same user profile 22.

In an embodiment, each virtual assistant 54 may be specialized based on products/services and/or location or other user profile characteristic such as moods for example. Indeed, the user profile 22 may be associated with a master virtual assistant 54 that coordinates a plurality of subsidiary virtual assistants 54. Indeed, the foregoing corresponds to the fragmentation of the virtual assistant software into subsidiary channels that can transact in tandem and simultaneously with various merchants as discussed herein. The subsidiary virtual assistants provide information directly to the user as discussed herein or to the master virtual assistant which will communicate the information to the user in a coordinated manner. For example, rather than displaying various purchase packages coming in separate from various virtual assistants, the master virtual assistant will present a single list with labels (e.g., “vacation packages”, “entertainment packages”, “Home”, “Florida” etc.). The user clicks on a package label to access the various packages provided to them by each subsidiary virtual assistant. For example, the user has a virtual assistant that is specialized in vacation packages and these results will be associated with the “vacation packages” label. In another example, the user has respective virtual assistants that transact for hockey tickets, concerts and movies and the results for purchase packages put together by these three subsidiary virtual assistants will be grouped under the “entertainment packages”. Another virtual assistant specializes for home needs such as groceries, repairs etc. and these packages will be associated with the “Home” label. If the user lives in Montreal but has a summer home in Florida, various packages put together by their subsidiary virtual assistant specialized for their Florida home and local activities will appear under the “Florida” label. Indeed, the foregoing can be considered also as one virtual assistant with a master or coordinator program (i.e. the master virtual assistant) and specialized or localized program (i.e. the subsidiary virtual assistant).

In an embodiment, a user can have different user IDs such as different VNs 26 and each is associated with separate and distinct virtual assistants 54 that are independent and uncoordinated.

With reference to FIG. 9, there is shown a client display 16 with a system provided chatbot interface 56 which can be a master chatbot interface, a modulated master chatbot interface or an individualized chatbot interface. The system controller 12 performs the computer implementable step of providing a merchant to advertise via the chatbot interface 56 in the form of an advertisement image 58 such as an icon, video, embedded image, and the like. Such advertisements can be allowed by clients via input commands, profile 22 parameters or preferences. The types of advertisements can also be modulated by the activity history of the client as recorded and registered by the system controller 12. In an embodiment, the client can select the image 58 by clicking on it for example in order to open the advertisement and view the full image or video or message or optionally opening up a sub-chatbot interface 60 which can be individualized to one merchant or relate to a small sub-group of merchants all of which are related to the advertisement.

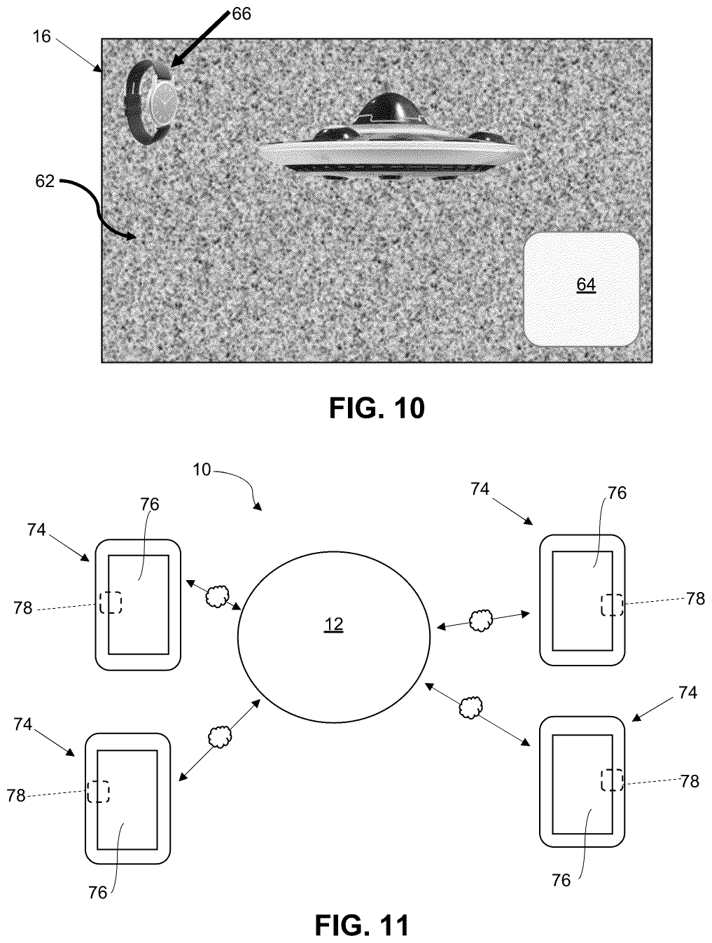

With reference to FIG. 10, there is shown a client interface 16 streaming a movie 62 provided by a participating merchant (such as a subscription streaming service). The system controller 12 provides for displaying a chatbot interface 64 overlapping the streamed movie 62. This chatbot interface 64 can be displayed via a client command (such as a voice command or clicking on an icon or selecting it from a menu made available via a system user interface etc.). In this way, the client can communicate directly with the subscription streaming service if there are any issues with the streaming service quality or movie 62. In an embodiment, the system controller 12 provides for merchant advertising via the chatbot interface 64 as previously described. In an embodiment, the system controller provides for embedding an image 66 such as a Picture in Pictures (PIP) image 66 directly embedded in the movie 62 that the client can click on to activate and receive an advertisement (such as an audio, video, audiovisual message and the like) or to activate the chatbot interface 64 and communicate with a merchant or merchants related to the image 66. Examples of the foregoing are provided in U.S. application Ser. No. 17/872,149 filed on Jul. 25, 2022 which is incorporated herein by reference in its entirety. Allowing, modulating, or blocking such images or auxiliary content is made possible by the system controller 12 via input commands, client responses to system prompted questions and/or client activity history as recorded and registered by the system controller 12.

The system 10 is a chatbot communications network providing client to client communications as well as merchant to merchant communication in addition to the client to merchant communication disclosed herein.

The system controller 12 provides for identifying device 14 physical location and translating chatbot communication to the location language or to the user preference language in the profiles. Indeed, language preferences can also be selected prior to a communication or entered in the profiles provided herein. For example, a client from the Province of Quebec can transact with a merchant in India. The merchant in India has most of its information in Hindi and the client in Quebec inputs questions in French. The system controller 12 translates the merchant information to the local language of the client i.e., French, and thus the chatbot provides merchant information to the client in French.

In an embodiment, the system controller 12 provides for a client user to search for merchants by locality. The user can input commands via the client interface 40 to search merchants locally or globally. For example, a client may want to transact with merchants in their city or merchants in a particular region or merchants around the world.

In an embodiment, the system controller 12 also executes the computer implementable step of providing an additional communications interface for users outside the chatbot interface for auxiliary system communications.

Turning now to FIG. 11, and as mentioned above, the system 10 provides a chatbot communications network between a plurality of users which may or may not be clients or merchants. It should be noted that the features described herein related to the clients and merchants can be attributed mutatis mutandis to any of the plurality of users and vice versa and as such, need not be repeated throughout for concision purposes only.

Each user has a respective user device 74 in operative remote communication with the system controller 12 via a network communication. The user device 74 is selected from the group consisting of a mobile device, a PC, a laptop, a server and the like and includes an input/output interface 76 for inputting commands to the system controller 12 and for outputting information from the system controller 12. The user device 74 comprises a controller 78 having a processor with an associated memory of processor executable code that when executed provides for performing computer implementable steps. The client device controller 78 is in operative remote communication with the system controller 12 via a networked communication.

The system controller 12 performs the computer implementable step of providing a chatbot communication between user devices 74.

In an embodiment, the system controller 12 executes the computer implementable steps of providing participating users to create respective profiles via input commands within the memory of the system controller 12. Indeed, the system controller 12 may not require such profiles and users can participate directly by logging into the system 10.

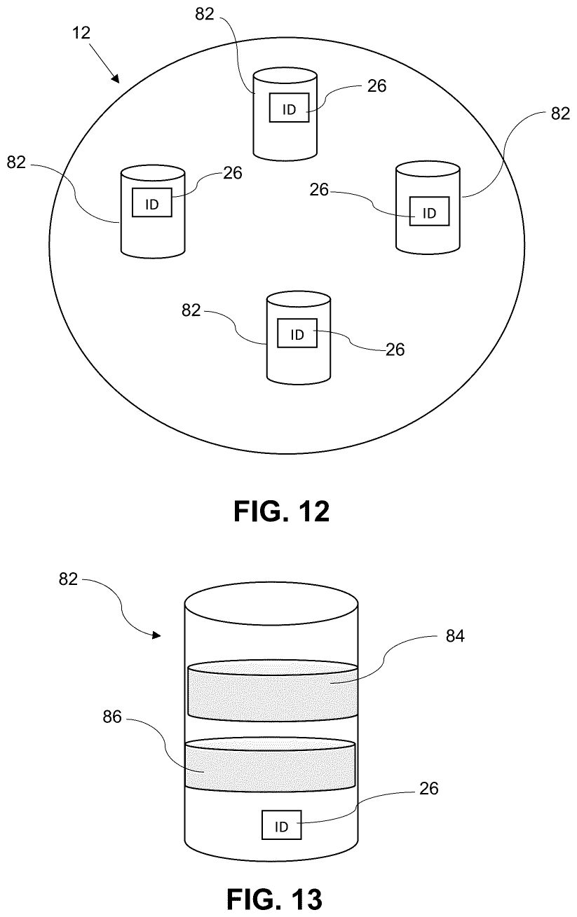

As shown in FIG. 12, the system controller 12 executes the computer implementable step of storing participating user profiles 82 in its memory. The system controller 12 performs the computer implementable step of creating distinct non-duplicated user identifications (ID) 26 associated with each user profile 82 as previously described.

Turning now to FIG. 13, a user profile 82 may include data related to the user as uploaded in their profile 82 including personal information, social network information, information related to their device 74 and/or their controller 78. In an embodiment, the user profile contains static information 84. In an embodiment, the user profile contains dynamic information 86. As previously discussed, static information 84 is related to uploaded user information such as gender, birthday, profession etc. As previously discussed, dynamic information 86 is related to a user's online activity as registered by the controller 12. A user may have social network accounts such as Facebook™, Twitter™, LinkedIn™′ Instagram™, YouTube™ and the like. The existence and links to these may be directly uploaded in their static information 84. In an embodiment, the controller 12 performs the computer implementable step of monitoring the user's online activity (upon a user request for example that is stored in their profile 82) and can dynamically register the social network accounts of the user as they are created and store their activity within their profile 82. The foregoing can be accomplished if the controller 12 can follow the user via their ID 26. Indeed, the user can enable the controller 12 via enabling input commands to monitor them by associating their ID 26 with their other online accounts, profiles, emails, websites and/or via their devices that they use to create networks or other online activities such as e-shopping, gaming, chatting, browsing, streaming etc. Moreover, the controller 12 performs the computer implementable step of monitoring their activity online such as within the social networks or within their online activity.

Indeed, the online activity as defined above can be monitored and registered via artificial intelligence (AI) and machine learning capabilities stored within the memory of the controller 12 and implemented thereby. In this way, user profiles 82 contain real time relevant online activity information such as the type of products one purchases, the type of photos and activities users post online, the chat rooms they participate in, the movies they stream and so on and so forth.

The controller 12 performs the computer implementable step of allowing users to seek out other users with corresponding or compatible profiles based on user inputs stored within their profile 82. For example, users may enable the controller via enabling input commands to suggest connections with users in their locality that have the same ethnic background and/or speak the same language and/or enjoy the same online activities (movies, games) and/or have similar professional backgrounds and/or have similar contacts and/or visit the same places in their locality or vacation in similar destinations or browse the same websites etc. Users can have the controller 12 dynamically make contact suggestions or may add emphasis on certain aspects of their profile and/or online activity in order for the controller 12 to make contact suggestions based on user predetermined selection criteria in their profiles 82 either statically or updated dynamically as provided herein.

Thus, a user profile 82 can contain a user's online information such as for example, their social network (e.g. their Facebook™ or LinkedIn™) pages/profiles, their business webpage, their videos (e.g. posted on YouTube™) or elsewhere etc.

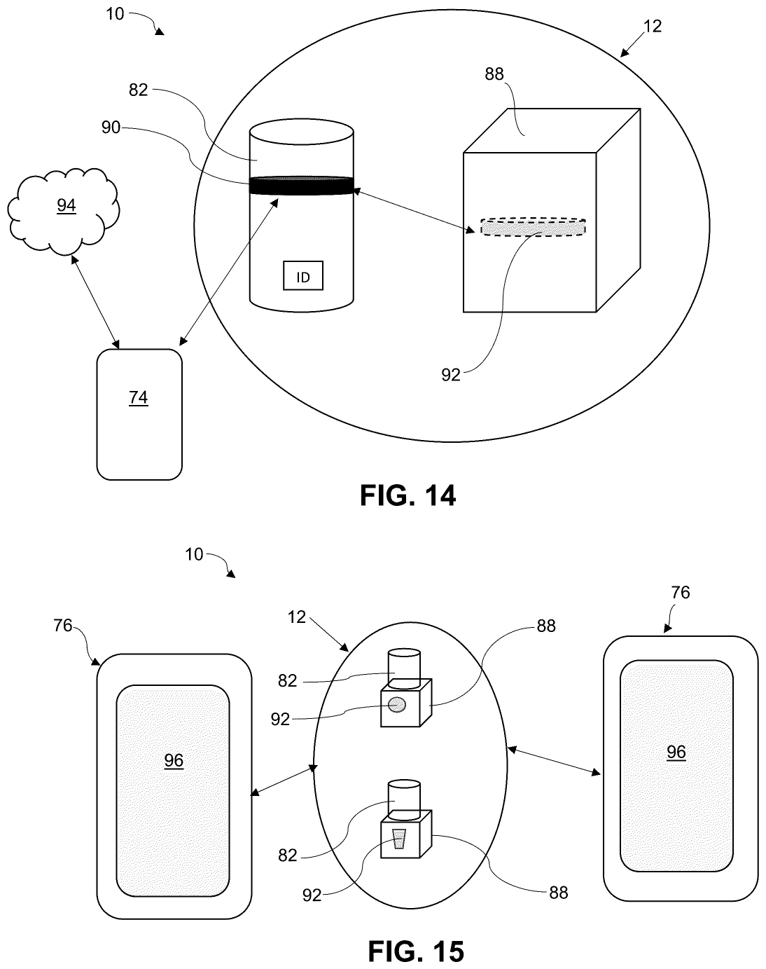

Turning to FIG. 14, the system controller 12 performs the computer implementable step of creating a chatbot framework 88 for each user profile 82. The system controller 12 performs the computer implementable step of converting in real time user content 90 associated with a given user into the chatbot framework 88, wherein the chatbot framework 88 stores the converted content 92 therein in real time.

The user content associated with each users is selected from the group consisting of: (i) content stored within the memory of the user controller including the user profile 82 for example; (ii) content stored within a memory of another remote controller associated with the respective user, including for example the system controller 12, and accessible via the user controller 78, (iii) online content associated with the respective user and accessible via the user controller 78 and any combination of (i), (ii) and (iii).

The online content 90 relates to the user's accounts on websites or user owned or controlled websites available via the internet 94 and accessible via a user device 74.

The user content 90 includes without limitation videos, websites, web pages, emails, encrypted data, computer files, digital data, software applications etc. as is known in the art.

In an embodiment, software applications include a chatbot application which can be converted into the converted chatbot content 92 within the context of the present disclosure.

With reference to FIG. 15, the system controller 12 performs the computer implementable step of creating a user chatbot interface 96 to be displayed via the user input/output interface 76. The system controller 12 has stored chatbot frameworks 88 associated with respective user profiles 82 and provides each user with a chatbot interface 96. Users can access the converted content 92 within the chatbot frameworks 88 of other users via their chatbot interface 96. The foregoing can be done by the virtual assistant applications provided herein. Moreover, users can have multiple chatbot frameworks 88 and these can be managed by a master chatbot framework as provided herein. In this way, users can communicate with each other via chatbot communication.

For example, an initiator user may request information from a responder user via the system 10. In this example, the responder user has access to online content in the form of a variety of social networks (including professional networks, general personal networks and the like). This online content is converted into converted content 92 within the responder user's chatbot framework 88. The controller 12 performs the computer implementable step of providing the responder user to enable the initiator user to access the converted content 92. The enabling may be based on the predetermined selection criteria discussed above or may be accomplished in real time. For example, a message can be sent to the responder user that an initiator user wishes to communicate via chatbot. The responder may choose to enable chatbot communication. The responder may elect via input commands to the controller 12 to access profile information related to the initiator user and then choose to enable chatbot communication based on the accessed profile information (such as name or location or other personal or professional or online activity information), the initiator may elect via input commands to the controller 12 (including stored profile information) to allow the responder to access or not their profile information.

Therefore, instead of an initiator user browsing a responder user's Facebook™ or LinkedIn™ pages they can ask via their chatbot interface 96 queries for information that would be normally posted on such social networks accounts and the chatbot framework 88 (or master framework) retrieves the information requested (from these social network pages) via the converted content 92 stored therein. Indeed, the communicating users (whether initiators or responders) can communicate on the communication sections (e.g. messenger, walls etc.) of these social networks via the chatbot interface 96.

In an embodiment, when the system controller 12 detects data video format content 90 and starts converting it into chatbot content 92, the voice recording of the video will be converted into written form transcription. The system controller 12 breaks the video content into video segments corresponding to time stamps. Each time stamp corresponds to a segment of the wherein a given time segment corresponds to the corresponding to a segment of the written form transcript. Therefore, when an initiating user searches for a part of a video within the chatbot content, the chatbot interface displays both the transcription and the video segment related to the search. Indeed, machine learning and AI applications can create a corresponding match between an initiator user or client search and related segments of video and transcript content.

In an embodiment, the system controller 12 converts user/merchant content provided herein into a corresponding chatbot framework and searches that content using AI or NLP to find the best results (based on initiator user/client search) from this content to communicate (visually or by voice) to the initiator user or client in a language form.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. A computer-implemented system providing a chatbot communications network between a plurality of system participating users, the system comprising:
a system controller comprising a processor with an associated memory of computer executable code that when executed provides the system controller of performing computer implementable steps;
at least two user devices associated with at least two respective users, wherein each of the user devices comprises:
a user controller in operative remote communication with the system controller via a network communication and comprising a processor with an associated memory, the user controller enabling internet access via a network communication; and
an input/output interface in operative communication with the user controller and providing for inputting commands to the system controller and for outputting information from the system controller;
user content associated with each of the respective users and being selected from the group consisting of: (i) content stored within the memory of the user controller, (ii) content stored within a memory of another remote controller associated with the respective user and accessible via the user controller, (iii) online content associated with the respective user and accessible via the user controller and any combination thereof,
wherein the computer implementable steps performed by the system controller comprise:
creating at least one chatbot framework associated with each participating user requesting same via input commands;
converting in real time the user content into converted chatbot content within the chatbot framework;
creating a user interface to be communicated to users via the input/output interface;
receiving input queries and/or commands from the at least one initiator user related to user content of another responder user via the user chatbot interface;
providing for the chatbot framework to produce chatbot outputs related to the converted chatbot content of the responder user in response to the input queries and/or commands; and
communicating the chatbot outputs via the user chatbot interface to the initiator user.

2. A computer-implemented system according to claim 1, wherein the computer implementable steps performed by the system controller further comprise:
storing the converted chatbot content within the chatbot framework.

3. A computer-implemented system according to claim 1, wherein the step of providing the chatbot framework to produce chatbot outputs comprises the computer implementable steps of:
analyzing the input queries and/or commands to provide analyzed input;
searching the converted chatbot content based on the analyzed input; and
determining at least one match between the analyzed input and relevant content of the searched converted chatbot content, wherein the chatbot outputs comprise the relevant content.

4. A computer-implemented system according to claim 3, wherein the system controller performs the computer implementable step of transferring the received input queries and/or commands to the chatbot framework.

5. A computer-implemented system according to claim 1, wherein the chatbot framework is stored within the system controller associated memory.

6. A computer-implemented system according to claim 1, wherein the chatbot framework is stored within the user controller memory.

7. A computer-implemented system according to claim 1, wherein the system controller performs the computer implementable step of providing participating users to create with input commands, via the input/output interface of respective ones of the user devices, respective user profiles associated with respective user identifiers and stored within the system controller memory.

8. A computer-implemented system according claim 7, wherein the system controller performs the computer implementable step of communicating the respective user identifiers via the input/output interface thereby providing a given participating user to select another given participating user for inquiring about the user content thereof by selecting a given user identifier associated therewith via input commands via the input/output interface.

9. A computer implemented system according to claim 1, wherein the system controller performs the computer implementable steps of:
creating a master chatbot interface to be communicated to the initiator user via the input/output interface for providing the initiator user to simultaneously input queries and/or commands related to one or more of the user content of one or more of the responder users;
creating a master chatbot framework stored in the system controller memory for coordinating the respective ones of the chatbot frameworks associated with the respective ones of the responder users;
providing the master chatbot framework to coordinate the chatbot outputs simultaneously and/or concurrently produced by the respective ones of the chatbot frameworks in response to the simultaneous input queries and/or commands thereby producing a coordinated collective chatbot output; and
communicating the coordinated collective chatbot output via the master chatbot interface.

10. A computer-implemented system according to claim 7, wherein the system controller performs the computer implementable step of monitoring user activity of a given one of the participating users and registering this using activity within a respective one of the user profiles associated with the given one of the participating users.

11. A computer-implemented system according to claim 7, wherein the system controller performs the computer implementable step of creating an artificial-intelligence (AI) generated virtual assistant associated with a respective user profile for inputting queries and/or commands via the chatbot interface related to the responder user content based on the user profile of the initiator user.

12. A computer-implemented system providing a chatbot communications network between a plurality of system participating merchants and system participating clients, the system comprising:
a system controller comprising a processor with an associated memory of computer executable code that when executed provides the system controller of performing computer implementable steps;
at least one client device associated with at least one client in operative remote communication with the system controller via a network communication and comprising an input/output interface for inputting commands to the system controller and for outputting information from the system controller;
at least one merchant controller associated with at least one system participating merchant being in operative remote communication with the system controller via a networked communication and comprising a processor with an associated memory comprising stored merchant content directed to potential system participating clients;
wherein the computer implementable steps performed by the system controller comprise:
creating at least one chatbot framework for the at least one merchant controller;
converting in real time the stored merchant content into converted chatbot content within the chatbot framework;
creating a client chatbot interface to be communicated to clients via the input/output interface;
receiving input queries and/or commands from the at least one client device related to merchant content via the client chatbot interface;
providing for the chatbot framework to produce chatbot outputs related to the converted chatbot content in response to the input queries and/or commands; and
communicating the chatbot outputs via the client chatbot interface.

13. A computer-implemented system according to claim 12, wherein the computer implementable steps performed by the system controller further comprise:
storing the converted chatbot content within the chatbot framework.

14. A computer-implemented system according to claim 12, wherein the step of providing the chatbot framework to produce chatbot outputs comprises the computer implementable steps of:
analyzing the input queries and/or commands to provide analyzed input;
searching the converted chatbot content based on the analyzed input; and
determining at least one match between the analyzed input and relevant content of the searched converted chatbot content, wherein the chatbot outputs comprise the relevant content.

15. A computer-implemented system according to claim 14,
wherein the system controller performs the computer implementable step of transferring the received input queries and/or commands to the chatbot framework.

16. A computer-implemented system according to claim 12, wherein the chatbot framework is stored within the system controller associated memory.

17. A computer-implemented system according to claim 12, wherein the chatbot framework is stored within the merchant controller memory.

18. A computer-implemented system according to claim 12, wherein the system controller performs the computer implementable step of providing participating clients to create with input commands, via the input/output interface of respective ones of the client device, respective client profiles associated with respective client identifiers and stored within the system controller memory.

19. A computer-implemented system according to claim 12, wherein the system controller performs the computer implementable step of providing a plurality of participating merchants associated with respective ones of the merchant controller to create with merchant controller input commands. respective merchant profiles associated with respective merchant identifiers stored within the system controller memory, wherein each of the respective ones of the merchant controller comprises respective merchant content and is associated with respective ones of the chatbot framework created therefor by the system controller.

20. A computer-implemented system according claim 19, wherein the system controller performs the computer implementable step of communicating the respective merchant identifiers via the client input/output interface thereby providing a given participating client to select a given participating merchant for inquiring about the merchant content thereof by selecting a given merchant identifier with input commands via the client input/output interface.

21. A computer implemented system according to claim 19, wherein the system controller performs the computer implementable steps of:
creating a master chatbot interface to be communicated to clients via the input/output interface for providing clients to simultaneously input queries and/or commands related to one or more of the respective merchant content of the respective ones of the merchant controller;
creating a master chatbot framework stored in the system controller memory for coordinating the respective ones of the chatbot frameworks associated with the respective ones of the merchant controller;
providing the master chatbot framework to coordinate the chatbot outputs simultaneously and/or concurrently produced by the respective ones of the chatbot frameworks in response to the simultaneous input queries and/or commands thereby producing a coordinated collective chatbot output; and
communicating the coordinated collective chatbot output via the master chatbot interface.

22. A computer-implemented system according to claim 18, wherein the system controller performs the computer implementable step of monitoring a given one of the client activity within the system and registering this activity within the client profile.

23. A computer-implemented system according to claim 18, wherein the system controller performs the computer implementable step of creating an artificial-intelligence (AI) generated virtual assistant associated with a respective client profile for inputting queries and/or commands via the chatbot interface related to the merchant content based on the client profile.
